(19) United States
(12) Patent Application Publication
(10) Pub. No.: US 2007/0261805 A1
(43) Pub. Date: Nov. 15, 2007

(54) Light partition assembly

(76) Inventor: Shu-Chen Huang, Chiayi City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/433,337

(22) Filed: May 12, 2006

(51) Int. Cl. E06B 9/24

(52) U.S. Cl. 160/371

(57) ABSTRACT

A partition assembly includes a plurality of parallel arranged upright posts, a plurality of transverse support posts, a plurality of first connecting plates, a plurality of second connecting plates, and a plurality of panels. Thus, the limit slot of each of the panels is hooked on the locking hook of the respective support post so that each of the panels is mounted on the respective support post easily and quickly without needing any screw member, thereby facilitating a user mounting the panels.

### BACKGROUND OF THE INVENTION

1. Field of the Invention

The present invention relates to a partition assembly and, more particularly, to a light partition assembly for a house.

2. Description of the Related Art

A conventional partition assembly for a house in accordance with the prior art shown in FIGS. 11 and 12 comprises a plurality of parallel arranged upright posts 10 each having two through holes 11, a plurality of transverse support posts 12 mounted between the upright posts 10 and each extended through the respective through hole 11 of the respective upright post 10, and a plurality of panels 13 mounted on two sides of the upright posts 10 by locking screws 14. Each of the upright posts 10 is made of a steel material and has a substantially C-shaped cross-sectional profile. Some of the upright posts 10 laminate each other so that the laminated upright posts 10 are located between the ceiling and the ground. However, it is necessary screw the locking screws 14 into the panels 13 and the upright posts 10, thereby causing inconvenience to the user. In addition, the locking screws 14 are exposed from the panels 13, thereby decreasing the aesthetic quality of the partition assembly.

### BRIEF SUMMARY OF THE INVENTION

In accordance with the present invention, there is provided a partition assembly, comprising a plurality of parallel arranged upright posts each having a first side and a second side, a plurality of transverse support posts mounted between the upright posts and each having a first end and a second end, a plurality of first connecting plates each mounted on the first end of a respective one of the support posts and each connected to the first side of a respective one of the upright posts, a plurality of second connecting plates each mounted on the second end of a respective one of the support posts and each connected to the second side of a respective one of the upright posts, and a plurality of panels each suspended on a respective one of the support posts.

The primary objective of the present invention is to provide a partition assembly, wherein the limit slot of each of the panels is hooked on the locking hook of the respective support post so that each of the panels is mounted on the respective support post easily and quickly without needing any screw member, thereby facilitating a user mounting the panels.

Another objective of the present invention is to provide a partition assembly, wherein, wherein the first connecting portion and the second connecting portion are connected when any two adjacent panels are juxtaposed so that the panels are joined rigidly and stably.

A further objective of the present invention is to provide a partition assembly, wherein each of the first connecting plates and the second connecting plates is locked onto the respective upright post by the locking slits so that the first connecting plates and the second connecting plates are connected with the upright posts rigidly and stably.

A further objective of the present invention is to provide a partition assembly, wherein the first connecting plates and the second connecting plates are mounted on and detached from the upright posts easily and quickly, thereby facilitating the user assembling and disassembling the partition assembly.

A further objective of the present invention is to provide a partition assembly, wherein each of the second connecting plates has two receiving grooves to receive the insertion plates of the respective first connecting plate so that the first connecting plates are connected with the second connecting plates rigidly and stably to reinforce the whole strength of the partition assembly.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a partially exploded perspective view of a partition assembly in accordance with the preferred embodiment of the present invention.

FIG. 2 is a locally side plan cross-sectional view of a panel of the partition assembly as shown in FIG. 1.

FIG. 3 is a partially exploded perspective view of the partition assembly as shown in FIG. 1.

FIG. 4 is a partially perspective assembly view of the partition assembly as shown in FIG. 1.

FIG. 5 is a locally top plan cross-sectional assembly view of the partition assembly as shown in FIG. 1.

FIG. 6 is a locally side plan cross-sectional assembly view of the partition assembly as shown in FIG. 1.

FIG. 7 is a perspective view of a panel of the partition assembly in accordance with another preferred embodiment of the present invention.

FIG. 8 is a locally side plan cross-sectional view of the panel as shown in FIG. 6.

FIG. 9 is a partially exploded perspective view of a partition assembly in accordance with another preferred embodiment of the present invention.

FIG. 10 is a partially exploded perspective view of a partition assembly in accordance with another preferred embodiment of the present invention.

FIG. 11 is a partially perspective view of a conventional partition assembly in accordance with the prior art.

FIG. 12 is a locally top plan cross-sectional view of the conventional partition assembly as shown in FIG. 11.

### DETAILED DESCRIPTION OF THE INVENTION

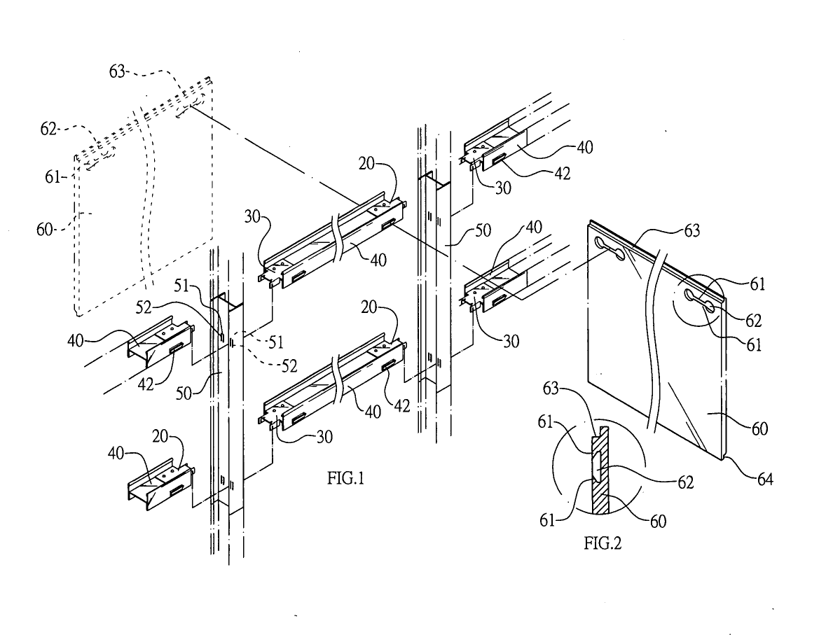

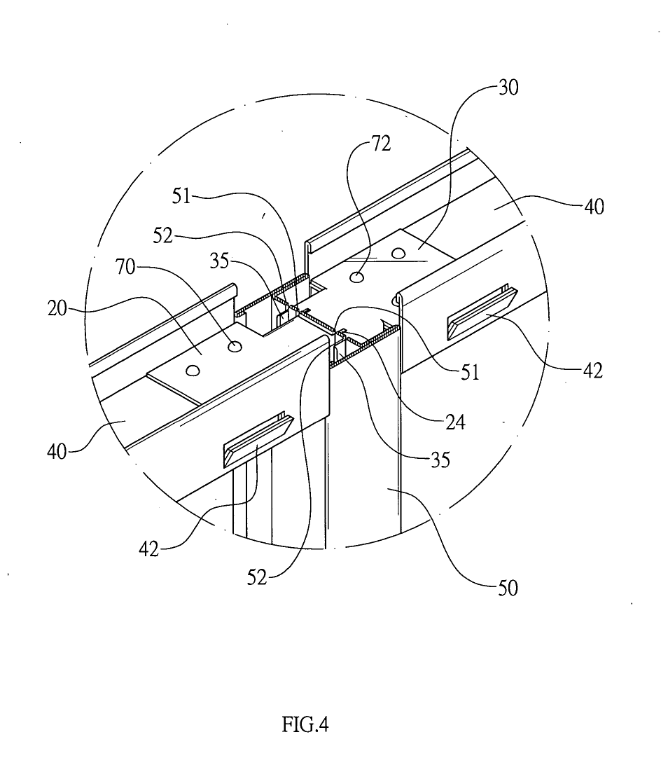

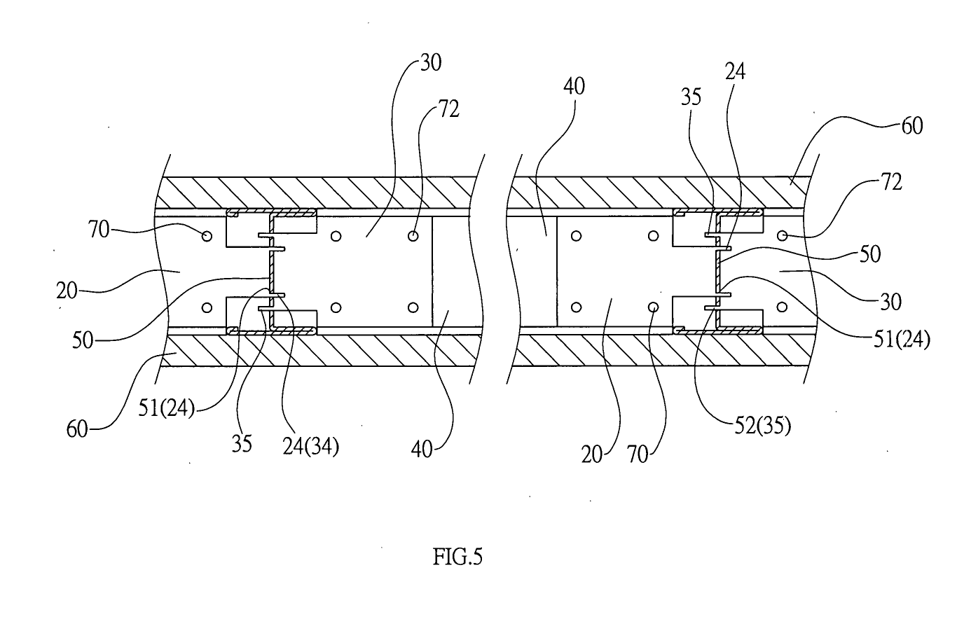

Referring to the drawings and initially to FIGS. 1-6, a partition assembly in accordance with the preferred embodiment of the present invention comprises a plurality of parallel arranged upright posts 50 each having a first side and a second side, a plurality of transverse support posts 40 mounted between the upright posts 50 and each having a first end and a second end, a plurality of first connecting plates 20 each mounted on the first end of a respective one of the support posts 40 and each connected to the first side of a respective one of the upright posts 50, a plurality of second connecting plates 30 each mounted on the second end of a respective one of the support posts 40 and each connected to the second side of a respective one of the upright posts 50, and a plurality of panels 60 each suspended on a respective one of the support posts 40.

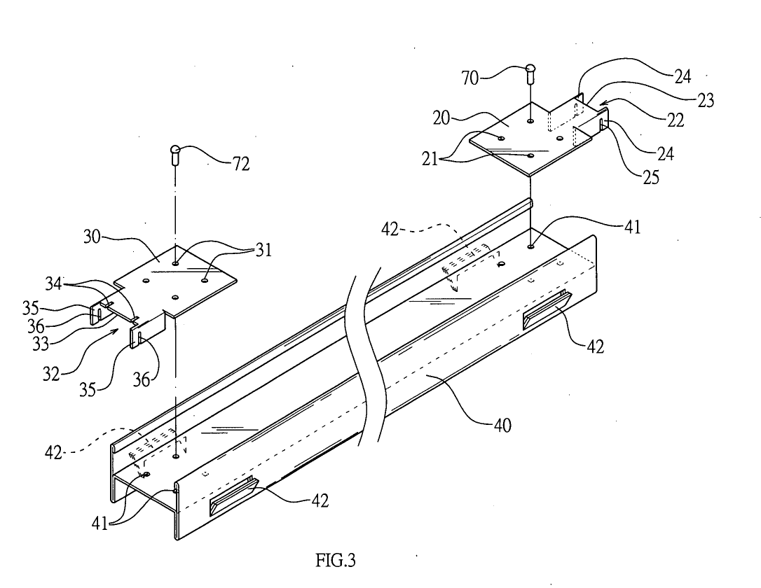

Each of the upright posts 50 is made of a steel material and has a substantially I-shaped cross-sectional profile. Some of the upright posts 50 laminate each other as shown in FIG. 2 so that the laminated upright posts 50 are located between the ceiling and the ground. Each of the upright posts 50 has two ends each formed with two axially extending inner slots 51 and two axially extending outer slots 52 located outside of the inner slots 51.

Each of the support posts 40 is made of a steel material and has a substantially I-shaped cross-sectional profile. Each of the support posts 40 has two opposite sides each provided with at least one outwardly extending locking hook 42. Each of the first end and the second end of each of the support posts 40 has a plurality of through holes 41.

Each of the first connecting plates 20 has a first end mounted on the first end of the respective support post 40 and a second end provided with two spaced protruding insertion plates 24 inserted into the inner slots 51 of the respective upright post 50. The first end of each of the first connecting plates 20 has a plurality of through holes 21 secured to the through holes 41 of the respective support post 40 by a plurality of rivets 70. Each of the insertion plates 24 of each of the first connecting plates 20 is formed with a locking slit 25 to receive an edge of the respective inner slot 51 of the respective upright post 50 to lock each of the first connecting plates 20 onto the respective upright post 50. The second end of each of the first connecting plates 20 is formed with an opening 22 located between the insertion plates 24 to receive the first side of the respective upright post 50. The opening 22 of each of the first connecting plates 20 has a stop end 23 rested on the first side of the respective upright post 50.

Each of the second connecting plates 30 has a first end mounted on the second end of the respective support post 40 and a second end provided with two spaced protruding insertion plates 35 inserted into the outer slots 52 of the respective upright post 50. The first end of each of the second connecting plates 30 has a plurality of through holes 31 secured to the through holes 41 of the respective support post 40 by a plurality of rivets 72. Each of the insertion plates 35 of each of the second connecting plates 30 is formed with a locking slit 36 to receive an edge of the respective outer slot 52 of the respective upright post 50 to lock each of the second connecting plates 30 onto the respective upright post 50. The second end of each of the second connecting plates 30 is formed with an opening 32 located between the insertion plates 35 to receive the second side of the respective upright post 50. The opening 32 of each of the second connecting plates 30 has a stop end 33 rested on the second side of the respective upright post 50. The second end of each of the second connecting plates 30 is formed with two receiving grooves 34 located between the insertion plates 35 to receive the insertion plates 24 of the respective first connecting plate 20.

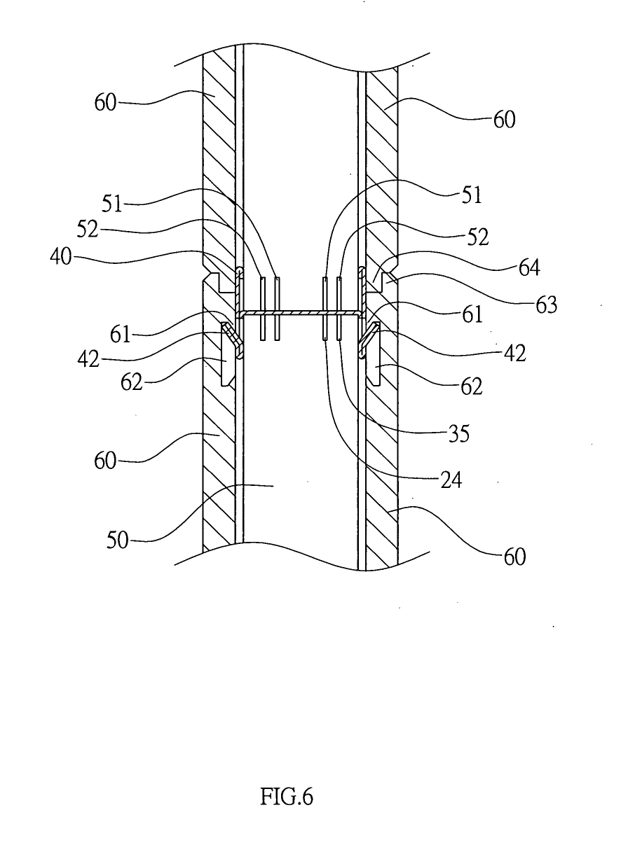

Each of the panels 60 is formed with at least one limit slot 62 hooked on the locking hook 42 of the respective support post 40. The limit slot 62 of each of the panels 60 is provided with a locking hook 61 locked onto the locking hook 42 of the respective support post 40. Each of the panels 60 has an upper end provided with a first connecting portion 63 and a lower end provided with a second connecting portion 64. Thus, the first connecting portion 63 and the second connecting portion 64 are connected with each other as shown in FIG. 6 when any two adjacent panels 60 are juxtaposed to each other to join the two adjacent panels 60.

Accordingly, the limit slot 62 of each of the panels 60 is hooked on the locking hook 42 of the respective support post 40 so that each of the panels 60 is mounted on the respective support post 40 easily and quickly without needing any screw member, thereby facilitating a user mounting the panels 60. In addition, the first connecting portion 63 and the second connecting portion 64 are connected when any two adjacent panels 60 are juxtaposed so that the panels 60 are joined rigidly and stably. Further, each of the first connecting plates 20 and the second connecting plates 30 is locked onto the respective upright post 50 by the locking slits 25 and 36 so that the first connecting plates 20 and the second connecting plates 30 are connected with the upright posts 50 rigidly and stably. Further, the first connecting plates 20 and the second connecting plates 30 are mounted on and detached from the upright posts 50 easily and quickly, thereby facilitating the user assembling and disassembling the partition assembly. Further, each of the second connecting plates 30 has two receiving grooves 34 to receive the insertion plates 24 of the respective first connecting plate 20 so that the first connecting plates 20 are connected with the second connecting plates 30 rigidly and stably to reinforce the whole strength of the partition assembly.

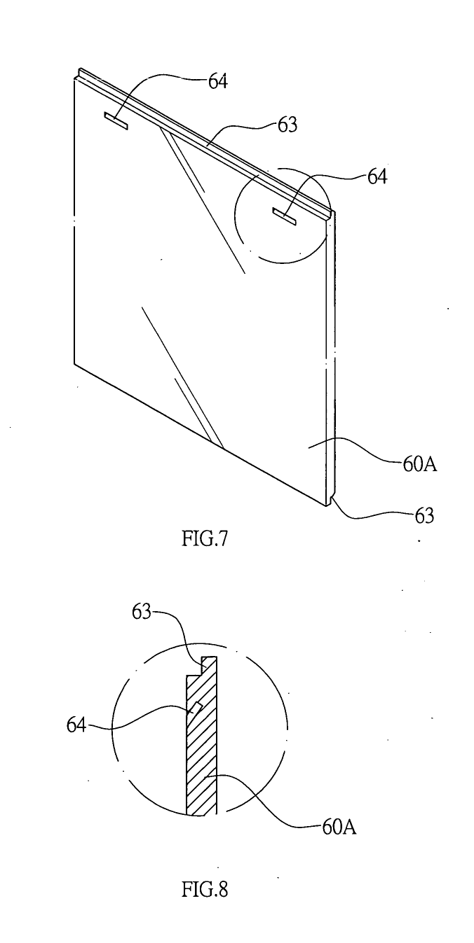

Referring to FIGS. 1, 7 and 8, each of the panels 60A is formed with at least one oblique limit slot 64 hooked on the locking hook 42 of the respective support post 40.

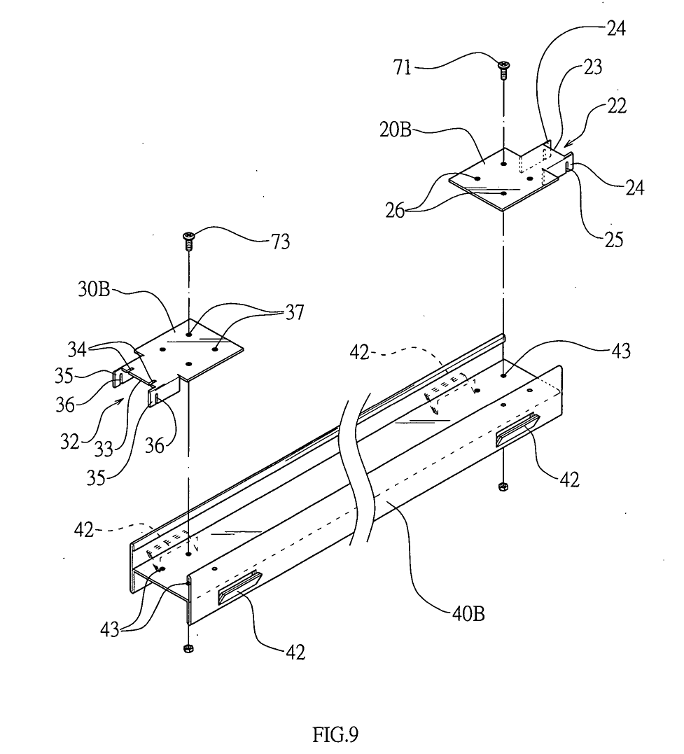

Referring to FIG. 9, each of the first end and the second end of each of the support posts 40B has a plurality of screw bores 42, the first end of each of the first connecting plates 20B has a plurality of screw bores 26 secured to the screw bores 42 of the respective support post 40B by a plurality of locking screws 71, and the first end of each of the second connecting plates 30B has a plurality of screw bores 37 secured to the screw bores 42 of the respective support post 40B by a plurality of locking screws 73.

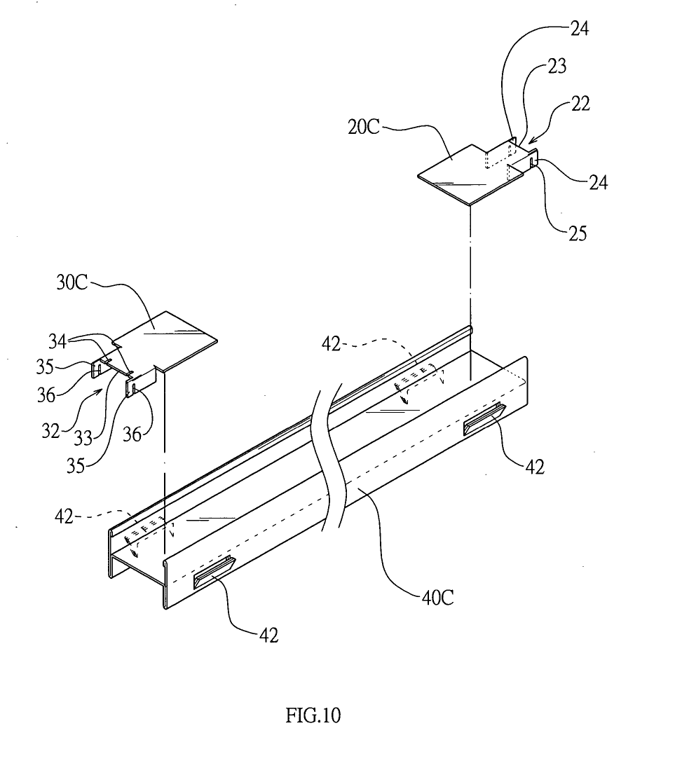

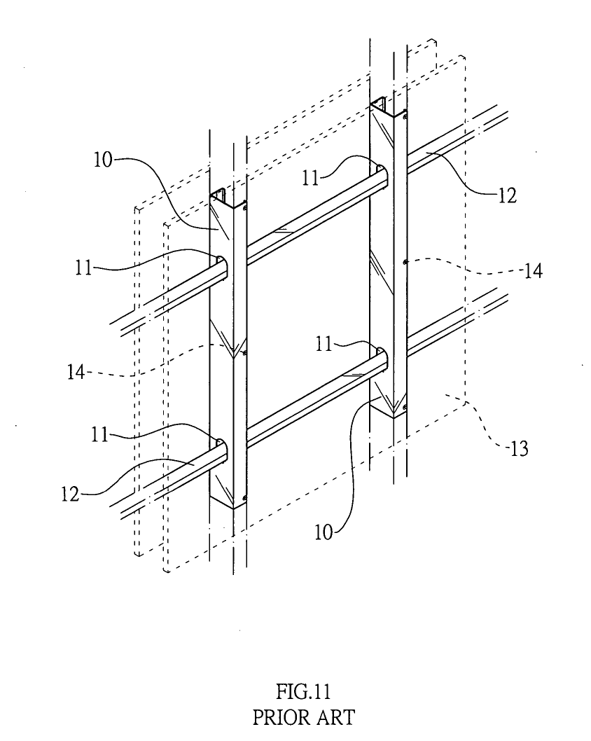

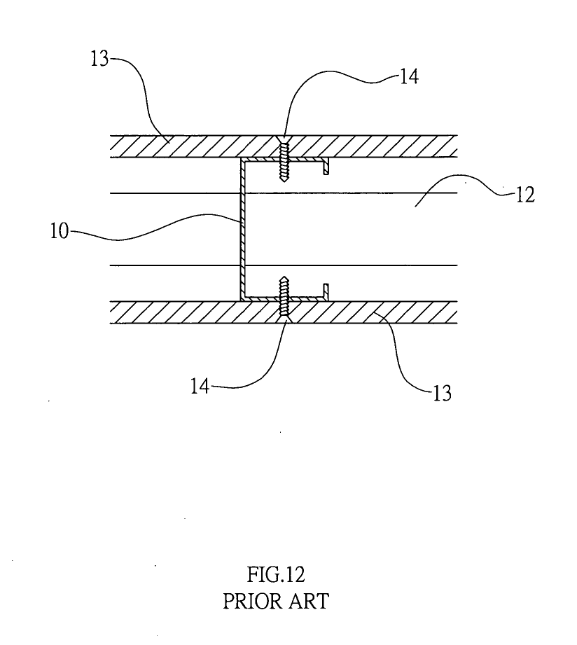

Referring to FIG. 10, the first end of each of the first connecting plates 20C is secured to the respective support post 40C by soldering, and the first end of each of the second connecting plates 30C is secured to the respective support post 40C by soldering.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A partition assembly, comprising:
a plurality of parallel arranged upright posts each having a first side and a second side;
a plurality of transverse support posts mounted between the upright posts and each having a first end and a second end;
a plurality of first connecting plates each mounted on the first end of a respective one of the support posts and each connected to the first side of a respective one of the upright posts;
a plurality of second connecting plates each mounted on the second end of a respective one of the support posts and each connected to the second side of a respective one of the upright posts;
a plurality of panels each suspended on a respective one of the support posts.

2. The partition assembly in accordance with claim 1, wherein each of the support posts has two opposite sides each provided with at least one outwardly extending locking hook, and each of the panels is formed with at least one limit slot hooked on the locking hook of the respective support post.

3. The partition assembly in accordance with claim 2, wherein the limit slot of each of the panels is provided with a locking hook locked onto the locking hook of the respective support post.

4. The partition assembly in accordance with claim 1, wherein each of the panels has an upper end provided with a first connecting portion and a lower end provided with a second connecting portion so that the first connecting portion and the second connecting portion are connected with each other when any two adjacent panels are juxtaposed to each other to join the two adjacent panels.

5. The partition assembly in accordance with claim 1, wherein each of the upright posts has two ends each formed with two axially extending inner slots and two axially extending outer slots located outside of the inner slots, each of the first connecting plates has a first end mounted on the first end of the respective support post and a second end provided with two spaced protruding insertion plates inserted into the inner slots of the respective upright post, and each of the second connecting plates has a first end mounted on the second end of the respective support post and a second end provided with two spaced protruding insertion plates inserted into the outer slots of the respective upright post.

6. The partition assembly in accordance with claim 5, wherein each of the insertion plates of each of the first connecting plates is formed with a locking slit to receive an edge of the respective inner slot of the respective upright post to lock each of the first connecting plates onto the respective upright post.

7. The partition assembly in accordance with claim 5, wherein the second end of each of the first connecting plates is formed with an opening located between the insertion plates to receive the first side of the respective upright post.

8. The partition assembly in accordance with claim 7, wherein the opening of each of the first connecting plates has a stop end rested on the. first side of the respective upright post.

9. The partition assembly in accordance with claim 5, wherein each of the insertion plates of each of the second connecting plates is formed with a locking slit to receive an edge of the respective outer slot of the respective upright post to lock each of the second connecting plates onto the respective upright post.

10. The partition assembly in accordance with claim 5, wherein the second end of each of the second connecting plates is formed with an opening located between the insertion plates to receive the second side of the respective upright post.

11. The partition assembly in accordance with claim 10, wherein the opening of each of the second connecting plates has a stop end rested on the second side of the respective upright post.

12. The partition assembly in accordance with claim 5, wherein the second end of each of the second connecting plates is formed with two receiving grooves located between the insertion plates to receive the insertion plates of the respective first connecting plate.

13. The partition assembly in accordance with claim 5, wherein each of the first end and the second end of each of the support posts has a plurality of through holes, the first end of each of the first connecting plates has a plurality of through holes secured to the through holes of the respective support post by a plurality of rivets, and the first end of each of the second connecting plates has a plurality of through holes secured to the through holes of the respective support post by a plurality of rivets.

14. The partition assembly in accordance with claim 1, wherein each of the support posts has two opposite sides each provided with at least one outwardly extending locking hook, and each of the panels is formed with at least one oblique limit slot hooked on the locking hook of the respective support post.

15. The partition assembly in accordance with claim 5, wherein each of the first end and the second end of each of the support posts has a plurality of screw bores, the first end of each of the first connecting plates has a plurality of screw bores secured to the screw bores of the respective support post by a plurality of locking screws, and the first end of each of the second connecting plates has a plurality of screw bores secured to the screw bores of the respective support post by a plurality of locking screws.

16. The partition assembly in accordance with claim 5, wherein the first end of each of the first connecting plates is secured to the respective support post by soldering, and the first end of each of the second connecting plates is secured to the respective support post by soldering.

17. The partition assembly in accordance with claim 1, wherein each of the upright posts has a substantially I-shaped cross-sectional profile.

18. The partition assembly in accordance with claim 1, wherein each of the support posts has a substantially I-shaped cross-sectional profile.
